(19) United States
(12) Patent Application Publication
(10) Pub. No.: US 2021/0293299 A1
(43) Pub. Date: Sep. 23, 2021

(54) LIQUID GAS SUPPORTING SHOCK ABSORBER AND VEHICLE USING SAME

(71) Applicant: Gang Chen, Haikou, Hainan (CN)

(72) Inventor: Gang Chen, Haikou, Hainan (CN)

(21) Appl. No.: 17/264,797

(22) PCT Filed: May 15, 2019
(86) PCT No.: PCT/CN2019/086922

§ 371 Date: Jan. 30, 2021

(30) Foreign Application Priority Data
Aug. 1, 2018 (CN) 201810863349.6
Aug. 1, 2018 (CN) 201821229111.X

(51) Int. Cl. F16F 9/53; F16F 9/06; F16F 9/34; F16F 9/32; F16F 9/512; B60G 13/08; B60G 17/08

(52) U.S. Cl. CPC F16F 9/537; B60G 2800/916; F16F 9/065; F16F 9/34; F16F 9/3292; F16F 9/512; B60G 13/08; B60G 17/08; F16F 2230/18; F16F 2222/12; F16F 2232/08; F16F 2234/02; F16F 2224/045; F16F 2228/066; F16F 2230/0047; F16F 2230/08; B60G 2400/60; B60G 2202/24; B60G 2204/62; B60G 2206/41; B60G 2500/104; B60G 2600/182; B60G 2600/26; B60G 2800/162; F16F 9/061

(57) ABSTRACT

A liquid gas supporting shock absorber. An oil path of the liquid gas supporting shock absorber, mainly composed of a liquid gas accumulator (4) and a single-acting hydraulic cylinder (7), is divided into a liquid inlet oil path (9) flowing into the single-acting hydraulic cylinder (7) and a liquid outlet oil path (6) flowing out of the single-acting hydraulic cylinder (7). A supporting force value of the liquid gas supporting shock absorber on an item supported thereby is measured using a force measuring element. A control component (1) compares the supporting force value to a set force value or a gravity value of the item supported by the supporting shock absorber, and the damping of the liquid inlet oil path (9) and the liquid outlet oil path (6) of the liquid gas supporting shock absorber is controlled by means of a mechanical, hydraulic or electronic control mode according to the result of the comparison, so as to adjust the supporting force value of the supporting shock absorber, so that the supporting force value of the supporting shock absorber is equal to or close to the set force value or the gravity value of the item supported by the supporting shock absorber.

### FIELD OF THE INVENTION

The invention relates to a liquid gas supporting shock absorber, which is particularly suitable for vehicle suspension and shock absorption.

### BACKGROUND OF THE INVENTION

The liquid gas supporting suspension is a type of supporting suspension that employees compressed gas as an elastic element and hydraulic oil as intermediate medium wherein the hydraulic oil is conveyed via a hydraulic cylinder; the shock absorption of the liquid gas supporting is controlled via a damping valve, a one-way valve and the like in a hydraulic cylinder controlling the damping so as to achieve the aim of shock absorption.

For a passive supporting shock absorber, the magnitude of the damping force generally depends on the magnitude of the pressure difference on two sides of a damping valve, the damping value thereof is not adjustable, the adaptability thereof is poor, and the shock absorption effect thereof is not ideal; the semi-active supporting shock absorber or the active shock absorber usually adopts an electric control mode to adjust the damping of a damping valve, and needs to use more complicated links such as data acquisition, processing, control and the like to control the damping of a throttling hole which exists disadvantages of many parts to be used, high cost, complicated control theory, method and data processing, and poor reliability, being one of the reasons that the current liquid gas suspension is not commonly used, and particularly, less used on a car.

### SUMMARY OF THE INVENTION

### Technical Problem

Firstly, liquid gas supporting shock absorber has poor shock absorption performance and poor adaptability to different road surfaces.

Secondly, liquid gas supporting shock absorber is complex in structure, more in parts for controlling damping control, high in cost and difficult to maintain.

Thirdly, liquid gas supporting shock absorber is low in reliability, and is particularly used for an active suspension system, and is more in parts, complex in control theory and high in failure rate.

### Technical Solution

An oil path of the liquid gas supporting shock absorber, mainly composed of a liquid gas accumulator and a single-acting hydraulic cylinder, is divided into a liquid inlet oil path flowing into the single-acting hydraulic cylinder and a liquid outlet oil path flowing out of the single-acting hydraulic cylinder. A supporting force value of the liquid gas supporting shock absorber on an item supported thereby is measured using a force measuring element. A control component compares the supporting force value to a set force value or a gravity value of the item supported by the supporting shock absorber, and the damping of the liquid inlet oil path and the liquid outlet oil path of the liquid gas supporting shock absorber is controlled by means of a mechanical, hydraulic or electronic control mode according to the result of the comparison, so as to adjust the supporting force value of the supporting shock absorber, so that the supporting force value of the supporting shock absorber is equal to or close to the set force value or the gravity value of the item supported by the supporting shock absorber.

The specific solutions are as follows,

Solution 1. A liquid gas supporting shock absorber (FIG. 1) comprises a liquid gas accumulator, a single-acting hydraulic cylinder, one-way valves (16, 12), damping valves (24, 25), a force measuring element, a control component (1) etc.;

The method is characterized in that: two groups of oil paths which are serially connected with damping valves (24, 25) and one-way valves (16, 12) form a liquid inlet oil path and a liquid outlet oil path which are connected in parallel between the hydraulic cylinder (7) and the liquid gas accumulator; the force measuring element measures a real-time supporting force value of the supporting shock absorber, the control component (1) compares the real-time supporting force value with a target force value, and then controls damping of the two damping valves (24, 25) respectively in a mechanical, hydraulic or electric control mode and the like according to the comparison result so as to control flow and pressure of liquid flowing into the hydraulic cylinder (7) and flowing out of the hydraulic cylinder (7), so that the supporting force value of the supporting shock absorber is equal to or close to the set force value or the gravity value of the item supported by the supporting shock absorber.

Target force value: the supporting force value to be achieved by the liquid gas supporting shock absorber which can be the force value set according to the requirement or an approximate gravity value of the item supported by the supporting shock absorber.

Gravity value of the item supported by the supporting shock absorber: namely, the weight of the item supported by the supporting shock absorber, which can be calculated by the control component according to the real-time measurement value of the force measuring element, and the method comprises the following types:

Firstly, under the static state, the gravity value of the item supported by the supporting shock absorber is directly measured by the force measuring element.

Secondly, calculating the average supporting force value measured by the force measuring element in unit time by the control component according to the real-time measured value of the force measuring element, namely sampling the measured value of the force measuring element for a plurality of times in unit time, and calculating the average force value of the sampled samples to be used as an approximate gravity value of the item supported by the supporting shock absorber.

Thirdly, measuring the average force value of the support force value in unit time by adopting a simulation resistance-capacitance filtering circuit method, namely, smoothly filtering the real-time force value measured by the force measuring element into an approximate average force value through the resistance-capacitance filtering circuit (shown in FIG. 2), and taking it as an approximate gravity value of a support item supported by the supporting shock absorber.

Fourthly, calculating the average force value by calculating the average pressure of the liquid flow in the hydraulic cylinder by connecting damping holes between the liquid gas accumulator and the hydraulic cylinder in series. In the Solution 8 (FIG. 5), the control port (18) and the valve port (10) are communicated through the damping hole (27), so that the pressure in the main liquid gas accumulator (4) is close to the average pressure value of the hydraulic cylinder (7). The hydraulic cylinder (7) is communicated with the main liquid gas accumulator (4) via the damping hole (27); when the pressure in the hydraulic cylinder (7) increases or decreases, the pressure in the main liquid gas accumulator (4) can slowly increase or decrease along with the pressure of the hydraulic cylinder (7) due to the action of the damping hole (27), and the smaller the damping hole (27), the closer the pressure in the main liquid gas accumulator (4) is to the average force value of the hydraulic cylinder (7), and is taken as an approximate gravity value of a support item supported by the supporting shock absorber.

When the method of setting the force value is adopted as the target force value, the force value can be set through a pressure regulating spring or through input of a control component and the like.

A force measuring element: the device refers to a component which can directly or indirectly measure or set pressure or force value, such as a force measuring spring, a pressure setting spring, a pressure sensor, a force sensor and the like.

The functions of the control component: receiving and processing the real-time force value or the real-time pressure value measured by the force measuring element, calculating and determining the gravity value and the target force value or the target pressure value of the item supported by the supporting shock absorber, comparing the real-time measured value with the target value, outputting the control signal according to the comparison result, and controlling the damping of the damping valve.

For the liquid gas supporting shock absorber adopting the force sensor, the control component mainly comprises electronic elements and also comprises a single chip, a PLC and other programmable control components.

For mechanically or hydraulically controlled liquid gas supporting device, the control component is the component that associates the force measuring element with the damping valve. For instance, the spring loading is used as a supporting shock absorber for the force measuring element (as shown in FIG. 3), the pressure regulating spring (19) and the spool valve (15) directly act, namely, the pressure regulating spring and the spool valve (15) also have the function of a control component. The same is true when the supporting shock absorber adopts a liquid gas accumulator (as shown in FIG. 5) as a force measuring element, and the auxiliary liquid gas accumulator (23) and the spool valve (15) directly act, namely the auxiliary liquid gas accumulator (23) and the spool valve (15) also serve the functions of a control component.

The damping control method comprises the following steps:

When the real-time measured value of the sensor is larger than the target force value, the damping value of a damping valve on the liquid inlet oil path (9) of the hydraulic cylinder (7) is increased, and meanwhile, the damping value of a damper on the liquid outlet oil path (6) of the hydraulic cylinder (7) is reduced.

When the real-time measured value of the sensor is smaller than the target force value, the damping value of a damping valve on a liquid inlet oil path (9) of the hydraulic cylinder (7) is reduced, and meanwhile the damping value of a damper on a liquid outlet oil path (6) of the hydraulic cylinder (7) is increased.

Solution 2. The liquid gas supporting shock absorber as set forth in Solution 1 is characterized in calculating the average supporting force value measured by the force measuring element in unit time by the control component according to the real-time measured value of the supporting shock absorber measured by the force measuring element, and taking the average force value as the target force value.

The average force value is close to the gravity value of the item supported by the supporting shock absorber.

Solution 3. The liquid gas supporting shock absorber as set forth in Solution 1 is characterized in that the damping valve on the liquid inlet oil path and the damping valve on the liquid outlet oil path are integrated on a valve component; a left damping valve and a right damping valve which are formed by a valve block (11) and a spool valve (15) of the valve component are respectively a liquid inlet oil path damping valve and a liquid outlet oil path damping valve; the left side and the right side of the spool valve (15) are respectively provided with a control port (18) connected with the control component and a valve port (10) connected with the hydraulic cylinder; the valve port (10) is communicated with the liquid outlet valve port of the liquid inlet oil path damping valve and the liquid inlet valve port of the liquid outlet oil path damping valve; the valve block is provided with a liquid inlet valve port (14) of the liquid inlet damping valve and the liquid outlet valve port (13) of the liquid outlet damping valve; the liquid inlet valve port (14) of the liquid inlet damping valve is connected with the liquid inlet one-way valve (16) on the liquid inlet oil path, the liquid outlet valve port (13) of the liquid outlet damping valve is connected with a liquid outlet one-way valve (12) on the liquid outlet oil path, constituting the liquid inlet oil path and the liquid outlet oil path and connected with the main liquid gas accumulator (4); the liquid inlet one-way valve (16) and the liquid outlet one-way valve (12) can be integrated on the valve component or can be externally connected on the valve component; the control port (18) and the valve port (10) can be communicated, can not be communicated, and can also be communicated via the damping hole (27); the control component controls the spool valve (15) to move left and right through the control port (18) so as to control the damping of the damping valve.

Solution 4. An electronic control liquid gas supporting shock absorber constituted by the supporting shock absorber of Solution 1 is characterized in that the force measuring element mainly comprises a force measuring sensor or a pressure sensor, and the damping valve mainly comprises two paths of electric control dampers which are respectively connected in series with the liquid inlet one-way valve (16) and the liquid outlet one-way valve (12); the control component calculates the approximate gravity value of the item supported by the supporting shock absorber according to the measured value of the sensor, compares the real-time measured value of the sensor with the approximate gravity value of the item supported by the supporting shock absorber, and controls the damping value of the electric control damper according to the comparison result.

The electric control damper: the part that changes valve component damping via controlling current size, voltage size, conduction time etc., including proportional solenoid valve, magnetorheological damping valve, electrorheological attenuator etc.

Solution 5 (FIG. 1) A magnetorheological liquid gas supporting shock absorber formed by the liquid gas supporting shock absorber of Solution 1 is characterized in that the hydraulic medium is magnetorheological fluid, the force measuring element mainly comprises a force measuring sensor or a pressure sensor (26), and the damping valve mainly comprises two magnetorheological damping valves (25, 24); the control component (1) calculates the gravity value of the item supported by the supporting shock absorber according to the measured value of the sensor, compares the real-time measured value of the sensor with the gravity value of the item supported by the supporting shock absorber, and controls the damping value of the magnetorheological damping valves (25, 24) according to the comparison result.

Solution 6 (FIG. 2). The supporting shock absorber of Solution 3 further comprises proportional electromagnet (17), etc., which is characterized in that the force measuring element mainly comprises a force measuring sensor or a pressure sensor, and the control port (18) is completely communicated with the valve port (10); the control component calculates the gravity value of the item supported by the supporting shock absorber according to the measured value of the force measuring sensor, compares the real-time measured value of the force measuring sensor with the gravity value of the item supported by the supporting shock absorber, and controls the proportional electromagnet (17) to drive the spool valve (15) to move left and right according to the comparison result, thereby controlling the damping values of the two damping valves.

Solution 7 (FIG. 3). The supporting shock absorber of Solution 3 is characterized in that the force measuring element mainly comprises a pressure regulating spring (19), and the control component mainly comprises the pressure regulating spring (19) and a spool valve (15); the control port (18) is not communicated with the valve port (10), and a pressure regulating spring (19) is arranged on the control port (18), the force of the pressure regulating spring (19) directly acts on the spool valve (15) to be compared with the pressure of the valve port (10) and controls the spool valve (15) to move left and right, thereby controlling the damping of the two damping valves.

Solution 8 (FIG. 4). The supporting shock absorber of Solution 7 further comprises an electric control pressure regulating execution device (21), a control component mainly composed of a control component (1), a force measuring element composed of a pressure sensor or a force measuring sensor (8) and the like; the method is characterized in that the control component adjusts a preset pressure value of the pressure regulating spring (19) via electric control pressure regulating execution device (21) according to the approximate gravity value of the item supported by the supporting shock absorber measured by the force measuring element, the preset pressure value is compared with the pressure value of liquid flow in the hydraulic cylinder (7) loaded on the spool valve (15), and the spool valve (15) is controlled to move left and right so as to control the damping of the two damping valves.

The function of the pressure regulating execution component is to regulate the preset force value of the pressure regulating spring.

Solution 9 (FIG. 5) The supporting shock absorber of Solution 3 is characterized in that the force measuring element is mainly composed of an auxiliary liquid gas accumulator (23); the control port (18) is not communicated with the valve port (10) or is communicated with the valve port (10) via the damping hole (27); the auxiliary liquid gas accumulator (23) is arranged on the control port (18), the pressure of the auxiliary liquid gas accumulator (23) acting on the spool valve (15) is compared with the pressure of the hydraulic cylinder of the valve port (10) acting on the spool valve (15) and pushes the spool valve (15) to move left and right so as to control the damping of the two damping valves.

Solution 10. A vehicle, such as a two-wheeled vehicle, a three-wheeled vehicle or a multi-wheeled vehicle, is characterized in that it adopts one of the supporting shock absorbers in the Solutions 1-9.

### Advantageous Effects

Firstly, the damping of the supporting shock absorber can be automatically adjusted according to the road condition of the vehicle in the running process, and the supporting shock absorber has self-adaptive damping function.

Secondly, the reliability of the supporting shock absorber is higher, the cost is lower, the shock absorption effect is better, and the adaptability is stronger.

Thirdly, compared with the active supporting shock absorber, the structure is simpler, and supporting shock absorber has an active shock absorption function.

### BRIEF DESCRIPTION OF THE DRAWINGS

FIG. 1 The schematic diagram illustrating the magnetorheological liquid gas supporting shock absorber.

FIG. 2 The schematic diagram illustrating the supporting shock absorber controlled by electromagnetic proportional valve.

FIG. 3 The schematic diagram illustrating the supporting shock absorber controlled by spring presetting.

FIG. 4 The schematic diagram illustrating the supporting shock absorber controlled by electric automatic control.

FIG. 5 The schematic diagram illustrating the supporting shock absorber controlled by liquid gas accumulator.

### REFERENCE NUMBERS FOR THE DRAWINGS

1—control component 2—control signal line 3—sensor signal line
4—main liquid gas accumulator 5—main liquid gas accumulator interface 6—liquid outlet oil path
7—hydraulic cylinder 8—force measuring sensor 9—liquid inlet oil path
10—valve port 11—valve block 12—liquid outlet one-way valve
13—liquid outlet valve port 14—liquid inlet valve port
15—spool valve 16—liquid inlet one-way valve 17—proportional electromagnet
18—control port on the valve block 19—pressure regulating spring 20—pressure regulating screw
21—pressure regulating execution device 22—motion block for pressure regulating execution device
23—auxiliary liquid gas accumulator 24—liquid outlet magnetorheological damping valve
25—liquid inlet magnetorheological damping valve 26—pressure sensor 27—damping hole

### DETAILED DESCRIPTION OF THE PREFERRED EMBODIMENTS

### Embodiments for the Invention

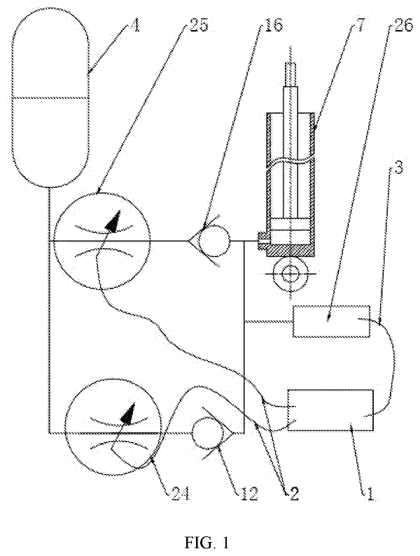

### Preferred Embodiment 1: As Shown in the Schematic Diagram Illustrating the Magnetorheological Liquid Gas Supporting Shock Absorber in FIG. 1

The supporting shock absorber includes: the main liquid gas accumulator (4) single-acting hydraulic cylinder (7), liquid inlet one-way valve (16), liquid outlet one-way valve (12), liquid outlet magnetorheological damping valve (24), liquid inlet magnetorheological damping valve (25), pressure sensor (26), control component (1), and so on. The liquid inlet oil path connected with the liquid inlet magnetorheological damping valve (25) and the liquid inlet one-way valve (16) in series and the liquid outlet oil path connected with the liquid outlet one-way valve (12) and the liquid outlet magnetorheological damping valve (24) in series are connected between the main liquid gas accumulator (4) and the hydraulic cylinder (7) in parallel. The pressure sensor (26) is connected to the oil circuit of the hydraulic cylinder (7) to measure the hydraulic pressure value in the hydraulic cylinder (7).

The working principle is as follows:

The control component (1) calculates the real-time pressure value and the average pressure value in unit time according to a pressure value measured by the pressure sensor (26), counts average pressure value in unit time as the target pressure value of the shock absorber to be compared with the real-time pressure value; and when the real-time pressure value of the pressure sensor (26) is greater than the target pressure value, control component (1) will output a control signal to increase the damping value of the liquid inlet magnetorheological damping valve (25) on the liquid inlet oil path (9) of the hydraulic cylinder (7) and reduce the damping value of the liquid outlet magnetorheological damping valve (24) on the liquid outlet oil path of the hydraulic cylinder (7).

When the real-time pressure value of the pressure sensor is smaller than the target pressure value, the control component (1) will output a control signal to reduce the damping value of the liquid inlet magnetorheological damping valve (25) on the liquid inlet oil path (9) of the hydraulic cylinder (7) and increase the damping value of the liquid outlet magnetorheological damping valve (24) on the liquid outlet oil path of the hydraulic cylinder (7).

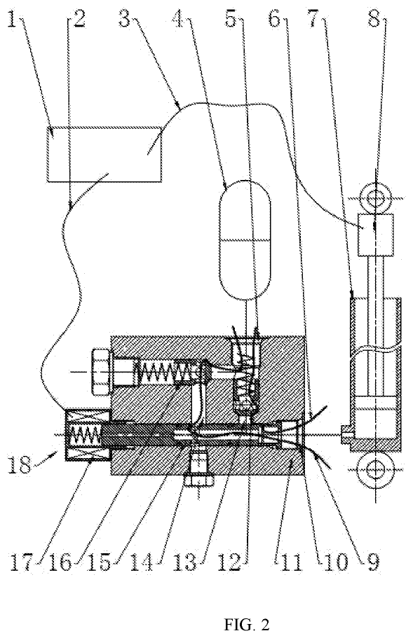

### Preferred Embodiment 2: As Shown in the Schematic Diagram Illustrating the Supporting Shock Absorber Controlled by Electromagnetic Proportional Valve in FIG. 2

The supporting shock absorber also includes: the device mainly comprises two damping valves mainly composed of a valve block (11) and a spool valve (15), a force measuring element mainly composed of a force measuring sensor (8), a control component mainly composed of a control component (1), a liquid inlet one-way valve (16) and a liquid outlet one-way valve (12) integrated on the valve block (11), a proportional electromagnet (17) and the like. The main liquid gas accumulator (4) is respectively communicated with a liquid inlet valve port (14) and a liquid outlet valve port (13) of the spool valve (15) via the liquid inlet one-way valve (16) and a liquid outlet one-way valve (12), then is connected to the hydraulic cylinder (7) through a valve port (10), a control port (18) is communicated with the valve port (10), and the spool valve (15) is controlled by a proportional electromagnet (17) to move left and right.

The working principle is as follows:

The control component (1) calculates the real-time supporting force value and the average supporting force value in unit time according to a pressure value measured by the force measuring sensor (8), counts average supporting force value in unit time as the target supporting force value of the shock absorber to be compared with the real-time supporting force value; and when the real-time supporting force value of the force measuring sensor is greater than the target supporting force value, the control component (1) will output a control signal to control the proportional electromagnet (17) to move left, so as to drive the spool valve (15) to move left, then the damping value of the damping valve on the liquid inlet oil path (9) of the hydraulic cylinder (7) is increased, and the damping value on the liquid outlet oil path (6) of the hydraulic cylinder (7) is reduced.

When the real-time supporting force value of the force measuring sensor is smaller than the target force value, the control component (1) outputs a control signal to control the proportional electromagnet (17) to move to the right so as to drive the spool valve (15) is to move to the right, and the damping value of a damping valve on a liquid inlet oil path (9) of the hydraulic cylinder (7) is reduced, and the damping value on a liquid outlet oil path (6) of the hydraulic cylinder (7) is increased.

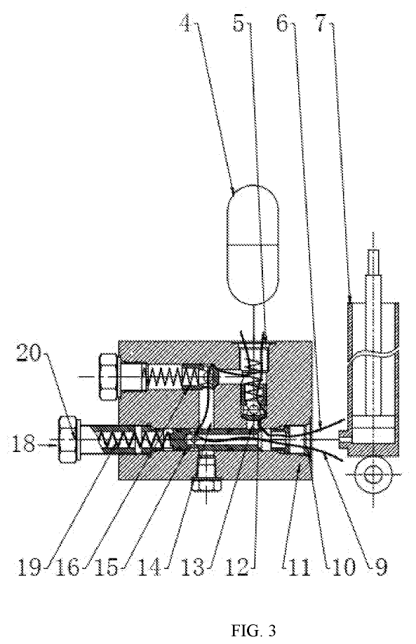

### Preferred Embodiment 3: As Shown in the Schematic Diagram Illustrating the Supporting Shock Absorber Controlled by Spring Presetting of FIG. 3

The supporting shock absorber includes: the device mainly comprises damping valves mainly composed of a valve block (11) and a spool valve (15), a liquid inlet one-way valve (16) and a liquid outlet one-way valve (12) integrated on the valve block (11), a force measuring element mainly composed of a pressure regulating spring (19), a control component mainly composed of a pressure regulating spring (19) and a spool valve (15). The main liquid gas accumulator (4) is respectively communicated with a liquid inlet valve port (14) and a liquid outlet valve port (13) of the spool valve (15) via the liquid inlet one-way valve (16) and a liquid outlet one-way valve (12), then is connected to the hydraulic cylinder (7) through the valve port (10), the control port (18) is not communicated with the valve port (10), a pressure regulating spring (19) is arranged on the control port, and the force of the pressure regulating spring (19) directly acts on the spool valve (15).

The working principle is as follows:

When the pressure of the valve port (10) is lower than the set force value of the pressure regulating spring (19), the spool valve (15) moves rightwards, the liquid flow resistance flowing into the hydraulic cylinder (7) from the main liquid gas accumulator (4) is reduced, and the liquid flow resistance flowing into the main liquid gas accumulator (4) from the hydraulic cylinder (7) is increased.

When the pressure of the valve port (10) is higher than the set force value of the pressure regulating spring (19), the spool valve (15) moves leftwards, the liquid flow resistance flowing into the hydraulic cylinder (7) from the main liquid gas accumulator (4) is increased, and the liquid flow resistance flowing into the main liquid gas accumulator (4) from the hydraulic cylinder (7) is reduced.

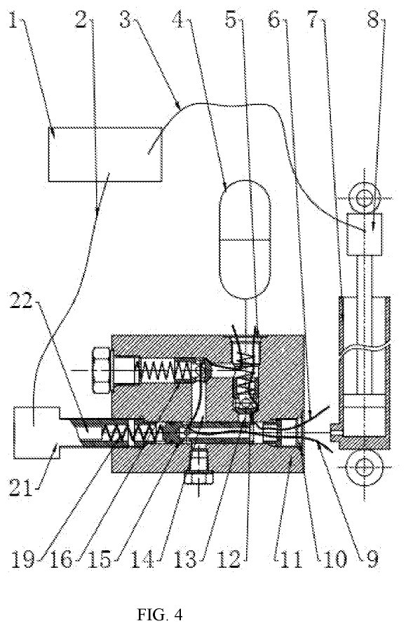

### Preferred Embodiment 4: As Shown in the Schematic Diagram Illustrating the Supporting Shock Absorber Controlled by Electric Automatic Control in FIG. 4

This supporting shock absorber includes: the damping valve mainly composed of a valve block (11) and a spool valve (15), a liquid inlet one-way valve (16) and a liquid outlet one-way valve (12) integrated on the valve block (11), a control component mainly composed of a control component (1), a force measuring element mainly composed of an electric control pressure regulating execution device (21), a force measuring sensor (8) and a pressure regulating spring (19) and the like. It is characterized in that the main liquid gas accumulator (4) is respectively communicated with a liquid inlet valve port (14) and a liquid outlet valve port (13) of the spool valve (15) via the liquid inlet one-way valve (16) and a liquid outlet one-way valve (12), then is connected to the hydraulic cylinder (7) through a valve port (10), the control port (18) is not communicated with the valve port (10), a pressure regulating spring (19) is arranged on the control port, and the force of the pressure regulating spring (19) directly acts on the spool valve (15). The control component adjusts a preset pressure value of the pressure regulating spring (19) via electric control pressure regulating execution device (21) according to the approximate gravity value of the item supported by the supporting shock absorber measured by the force measuring element, the preset pressure value is compared with the pressure value of liquid flow in the hydraulic cylinder (7) loaded on the spool valve (15), and the spool valve (15) is controlled to move left and right.

The working principle is as follows:

When the pressure of the valve port (10) is lower than the set force value of the pressure regulating spring (19), the spool valve (15) moves rightwards, the liquid flow resistance flowing into the hydraulic cylinder (7) from the main liquid gas accumulator (4) is reduced, and the liquid flow resistance flowing into the main liquid gas accumulator (4) from the hydraulic cylinder (7) is increased.

When the pressure of the valve port (10) is higher than the set force value of the pressure regulating spring (19), the spool valve (15) moves leftwards, the liquid flow resistance flowing into the hydraulic cylinder (7) from the main liquid gas accumulator (4) is increased, and the liquid flow resistance flowing into the main liquid gas accumulator (4) from the hydraulic cylinder (7) is reduced.

The function of the pressure regulating execution device (21) is to regulate the preset force value of the pressure regulating spring (19).

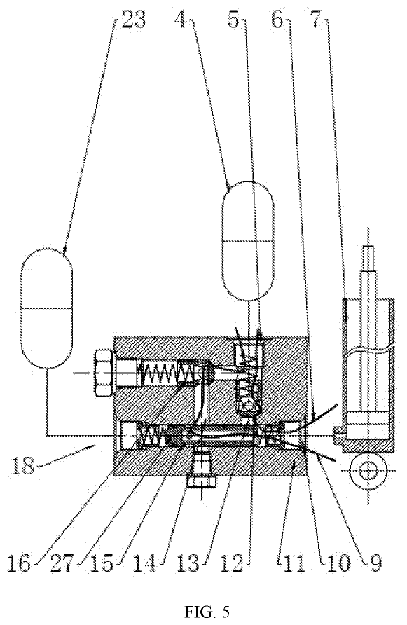

### Preferred Embodiment 5: As Shown in the Schematic Diagram Illustrating the Supporting Shock Absorber Controlled by Liquid Gas Accumulator in FIG. 5

This supporting shock absorber includes: the damping valve mainly composed of a valve block (11) and a spool valve (15), a liquid inlet one-way valve (16) and a liquid outlet one-way valve (12) integrated on the valve block (11). It is characterized in that the main liquid gas accumulator (4) is respectively communicated with a liquid inlet valve port (14) and a liquid outlet valve port (13) of the spool valve (15) via the liquid inlet one-way valve (16) and a liquid outlet one-way valve (12), then is connected to the hydraulic cylinder (7) through a valve port (10), the control port (18) is communicated with the valve port (10) via the damping hole (27); the auxiliary liquid gas accumulator (23) is connected with the control port (18). The hydraulic pressure in the auxiliary liquid gas accumulator (23) is close to the average pressure value in the hydraulic cylinder (7) due to the action of the damping hole (27).

When the shock absorber works, the pressure of the auxiliary liquid gas accumulator (23) loaded on the spool valve (15) is compared with the pressure of the valve port (10) loaded on the spool valve (15), when the pressure of the valve port (10) is higher than the pressure value of the auxiliary liquid gas accumulator (23), the spool valve (15) moves leftwards, then the liquid flow resistance flowing into the hydraulic cylinder (7) from the main liquid gas accumulator (4) is increased, and the liquid flow resistance flowing into the main liquid gas accumulator (4) from the hydraulic cylinder (7) is reduced; when the pressure of the valve port (10) is lower than the pressure value of the auxiliary liquid gas accumulator (23), the spool valve (15) moves rightwards, then the liquid flow resistance flowing into the hydraulic cylinder (7) from the main liquid gas accumulator (4) is reduced, and the liquid flow resistance flowing into the main liquid gas accumulator (4) from the hydraulic cylinder (7) is increased.

1. A liquid gas supporting shock absorber comprising
a liquid gas accumulator, a single-acting hydraulic cylinder, one-way valves, damping valves, a force measuring element, and a control component;
the method is characterized in that: two groups of oil paths which are serially connected with damping valves and one-way valves form a liquid inlet oil path and a liquid outlet oil path which are connected in parallel between the hydraulic cylinder and the liquid gas accumulator; the force measuring element measures a real-time supporting force value of the supporting shock absorber, the control component compares the real-time supporting force value with a target force value, and then controls damping of the two damping valves respectively in a mechanical, hydraulic or electric control mode and the like according to the comparison result so as to adjust the supporting force value of the supporting shock absorber to make the supporting force value of the supporting shock absorber is equal to or close to the target force value, and the damping control method is as follows:
when the real-time measured value of the force measuring element is larger than the target value, the damping value of a damping valve on the liquid inlet oil path (9) of the hydraulic cylinder (7) is increased, and meanwhile, the damping value of the damping valve on the liquid outlet oil path (6) of the hydraulic cylinder (7) is reduced;
when the real-time measured value of the force measuring element is smaller than the target force value, the damping value of a damping valve on a liquid inlet oil path (9) of the hydraulic cylinder (7) is reduced, and meanwhile the damping valve of the damping valve on a liquid outlet oil path (6) of the hydraulic cylinder (7) is increased.

2. The liquid gas supporting shock absorber of claim 1 wherein:
calculating the average supporting force value measured by the force measuring element in unit time by the control component according to the real-time measured value of the supporting shock absorber measured by the force measuring element, and taking the average force value as the target force value.

3. The liquid gas supporting shock absorber of claim 1 wherein:
the damping valve on the liquid inlet oil path and the damping valve on the liquid outlet oil path are integrated on a valve component;
a left damping valve and a right damping valve which are formed by a valve block (11) and a spool valve (15) of the valve component are respectively a liquid inlet oil path damping valve and a liquid outlet oil path damping valve;
the left side and the right side of the spool valve (15) are respectively provided with a control port (18) connected with the control component and a valve port (10) connected with the hydraulic cylinder;
the valve port (10) is communicated with the liquid outlet valve port of the liquid inlet oil path damping valve and the liquid inlet valve port of the liquid outlet oil path damping valve;
the valve block is provided with a liquid inlet valve port (14) of the liquid inlet damping valve and the liquid outlet valve port (13) of the liquid outlet damping valve;
the liquid inlet valve port (14) of the liquid inlet damping valve is connected with the liquid inlet one-way valve (16) on the liquid inlet oil path, the liquid outlet valve port (13) of the liquid outlet damping valve is connected with a liquid outlet one-way valve (12) on the liquid outlet oil path, constituting the liquid inlet oil path and the liquid outlet oil path and connected with the main liquid gas accumulator (4);
the liquid inlet one-way valve (16) and the liquid outlet one-way valve (12) can be integrated on the valve component or can be externally connected on the valve component;
the control port (18) and the valve port (10) can be communicated, can not be communicated, and can also be communicated via the damping hole (27);
the control component controls the spool valve (15) to move left and right through the control port (18) so as to control the damping of the damping valve.

4. An electronic control liquid gas supporting shock absorber constituted by the supporting shock absorber of claim 1 wherein:
the force measuring element mainly comprises a force measuring sensor or a pressure sensor, and the damping valve mainly comprises two paths of electric control dampers which are respectively connected in series with the liquid inlet one-way valve and the liquid outlet one-way valve;
the control component calculates the approximate gravity value of the item supported by the supporting shock absorber according to the measured value of the sensor, compares the real-time measured value of the sensor with the approximate gravity value of the item supported by the supporting shock absorber, and controls the damping value of the electric control damper according to the comparison result.

5. A magnetorheological liquid gas supporting shock absorber formed by the liquid gas supporting shock absorber of claim 1 wherein:
the hydraulic medium is magnetorheological fluid, the force measuring element mainly comprises a force measuring sensor or a pressure sensor, and the damping valve mainly comprises two magnetorheological damping valves (25, 24);
the control component (1) calculates the gravity value of the item supported by the supporting shock absorber according to the measured value of the sensor, compares the real-time measured value of the sensor with the gravity value of the item supported by the supporting shock absorber, and controls the damping value of the magnetorheological damping valves (25, 24) according to the comparison result.

6. The supporting shock absorber of claim 3 further comprises proportional electromagnet (17) wherein:
the force measuring element mainly comprises a force measuring sensor or a pressure sensor, and the control port (18) is completely communicated with the valve port (10);
the control component calculates the gravity value of the item supported by the supporting shock absorber according to the measured value of the force measuring sensor, compares the real-time measured value of the force measuring sensor with the gravity value of the item supported by the supporting shock absorber, and controls the proportional electromagnet (17) to drive the spool valve (15) to move left and right according to the comparison result, thereby controlling the damping values of the two damping valves.

7. The supporting shock absorber of claim 3 wherein:
the force measuring element mainly comprises a pressure regulating spring (19), and the control component mainly comprises the pressure regulating spring (19) and a spool valve (15); the control port (18) is not communicated with the valve port (10), and a pressure regulating spring (19) is arranged on the control port (18), the force of the pressure regulating spring (19) directly acts on the spool valve (15) to be compared with the pressure of the valve port (10) and controls the spool valve (15) to move left and right, thereby controlling the damping of the two damping valves.

8. The supporting shock absorber of claim 7, further comprises an electric control pressure regulating execution device (21) and a force measuring element composed of a pressure sensor or a force measuring sensor wherein:
the control component adjusts a preset pressure value of the pressure regulating spring (19) via electric control pressure regulating execution device (21) according to the approximate gravity value of the item supported by the supporting shock absorber measured by the force measuring element, the preset pressure value is compared with the pressure value of liquid flow in the hydraulic cylinder (7) loaded on the spool valve (15), and the spool valve (15) is controlled to move left and right so as to control the damping of the two damping valves.

9. The supporting shock absorber of claim 3 wherein:
the force measuring element is mainly composed of an auxiliary liquid gas accumulator (23); the control port (18) is not communicated with the valve port (10) or is communicated with the valve port (10) via the damping hole; the auxiliary liquid gas accumulator (23) is arranged on the control port (18); the pressure of the auxiliary liquid gas accumulator (23) acting on the spool valve (15) is compared with the pressure of the hydraulic cylinder of the valve port (10) acting on the spool valve (15) and pushes the spool valve (15) to move left and right so as to control the damping of the two damping valves.

10. A vehicle wherein it adopts one of the supporting shock absorbers in the claims 1-9.
